(19) United States
(12) Patent Application Publication
(10) Pub. No.: US 2016/0291633 A1
(43) Pub. Date: Oct. 6, 2016

(54) INTEGRATED COMPUTATIONAL ELEMENT FABRICATION METHODS AND SYSTEMS

(71) Applicant: HALLIBURTON ENERGY SERVICES, INC., Houston, TX (US)

(72) Inventor: James M. Price, The Woodlands, TX (US)

(73) Assignee: HALLIBURTON ENERGY SERVICES, INC., Houston, TX (US)

(21) Appl. No.: 15/036,400

(22) PCT Filed: Dec. 2, 2013
(86) PCT No.: PCT/US2013/072614

§ 371 Date: May 12, 2016

(51) Int. Cl. G06E 3/00; G05B 19/402; G01B 11/06

(52) U.S. Cl. CPC G06E 3/001; G01B 11/0633; G05B 19/402; G05B 2219/49021

(57) ABSTRACT

Methods and systems for manufacturing optical computing elements, including a method for correcting element layer thickness measurements during manufacturing that includes depositing an element layer on a glass substrate or a previously deposited layer, illuminating the deposited layer and sampling reflected or transmitted light produced by said illuminating, detecting and measuring an actual magnitude of the sampled light as a function of wavelength, and modeling the sampled light to produce a predicted magnitude of the sampled light. The method further includes determining a discrepancy between the actual and predicted magnitudes, adjusting the actual magnitude based on said discrepancy, calculating the thickness of the deposited layer based upon the adjusted actual magnitude of the sampled light, and adjusting the deposited layer's thickness if the calculated thickness is not within a tolerance range of a target thickness.

### BACKGROUND

Within the field of chemical analysis of materials, optical computing has developed as an alternative to conventional spectrometry. Optical computers used to perform such analysis incorporate an integrated computational element or ICE (also sometimes referred to as a multivariate optical element or MOE). In contrast to a spectrometer, which separates light reflected off of or refracted through a sample of interest for subsequent analysis, an ICE is uniquely tuned to a specific pattern of a material of interest. Optical computers are generally capable of producing results of comparable quality and accuracy as laboratory grade spectroscopic systems, but without the delays associated with the multivariate analysis performed by a digital computer on the measured spectrum provided by a spectrometer.

But ICEs are only as accurate and reliable as the manufacturing methods used to produce them. One significant factor that must be monitored closely in the production of ICEs is the thickness of each layer within an ICE's multilayer stack. Each layer's thickness can be monitored at different stages of the deposition process using an analytical instrument such as, for example, an ellipsometer or an infrared spectrometer. At predetermined stopping points within the production process, the ICE substrate is rotated to a position where a spectrum generated by a light beam reflected off of the ICE can be collected and measured. The measured spectrum may then be used to determine a layer's thickness or optical constants, allowing for corrections should process deviations be detected.

During the thickness measurement described above, it is possible for a portion of the incident or reflected light to be blocked or clipped (i.e., partially blocked). Blocking and/or clipping can result, for example, from improper or inconsistent rotation and positioning of the substrate during measurements or from contaminants present on the surface of the ICE. Such blocking/clipping can skew the analysis, resulting in a misinterpretation of the loss of signal as an intrinsic layer absorption, and thus erroneous thickness and/or optical constant determinations, producing a defective ICE. Further, even if the blocking/clipping is recognized, current production methods do not provide for any sort of corrective action during the analysis of the optical data, other than to abort the production run, correct the problem and start a new production run.

### BRIEF DESCRIPTION OF THE DRAWINGS

Accordingly, there is disclosed herein a novel method for correcting optically blocked and/or clipped integrated computational element (ICE) layer measurements. In the drawings:

FIG. 1 shows an illustrative ICE manufactured using the disclosed methods and systems.

FIGS. 2A and 2B show examples of chemical analysis systems implemented using illustrative ICEs manufactured using the disclosed methods and systems.

FIGS. 3A and 3B illustrate a layer thickness measurement of an illustrative ICE manufactured using the disclosed methods and systems, both without and with a contaminant obstructing the optical path.

FIG. 4 shows a flow diagram of an illustrative method for measuring an ICE layer thickness during manufacturing that accounts for optical clipping and/or blocking.

FIG. 5 shows an illustrative computer controlled ICE manufacturing system suitable for implementing the disclosed methods for the manufacture of an ICE.

FIG. 6A shows a plot of both a modeled and an actual ICE layer optical transmittance measurement without any correction to the modeled response.

FIG. 6B shows a plot of both a modeled and an actual ICE layer optical transmittance measurement using the disclosed methods to correct the modeled response.

It should be understood that the drawings and corresponding detailed description do not limit the disclosure, but on the contrary, they provide the foundation for understanding all modifications, equivalents, and alternatives falling within the scope of the appended claims.

### DETAILED DESCRIPTION

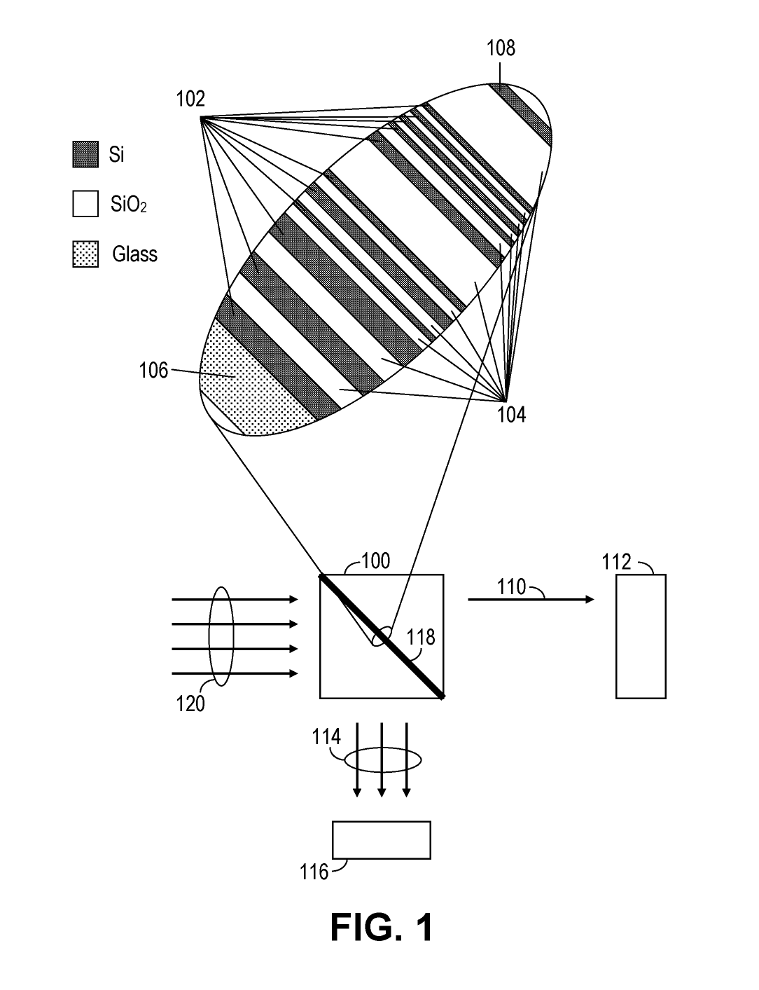

The disclosed systems and methods are best understood by first describing an illustrative integrated computational element (ICE), a type of optical computing element produced by such methods and systems, as well as various device configurations that incorporate such ICEs. Accordingly, FIG. 1 shows an illustrative ICE 118 integrated within an optical computer 100, together with an exploded view of the internal structure of the ICE 118. Illustrative ICE 118 includes multiple layers 102 and 104, shown respectively in FIG. 1 as silicon (Si, with a high index of refraction) and quartz (SiO₂, with a low index of refraction). Other materials, such niobia, niobium, germanium, germania, magnesium fluoride and silicon oxide, are known in the art and may also be used to form the various layers 102 and 104 of an ICE, as well as to form the outer layer 108. In at least some illustrative embodiments, the ICE is built up upon a substrate106 made of BK-7 optical glass. The number and thickness of each of the layers is determined based upon the spectral attributes of the material of interest that the ICE is designed to identify.

Continuing to refer to FIG. 1, light 120 reflected off of or transmitted through a sample of a material of interest is directed towards optical computer 100 and ICE 118 within it. In the example shown, the light with the spectrum of interest 110 passes through ICE 118 and continues on towards detector 112, while the remaining wavelengths of light 114 are reflected by ICE 118 towards detector 116. Detector 112 is typically configured to produce an output signal indicating the presence and/or concentration of a particular material of interest within the sample.

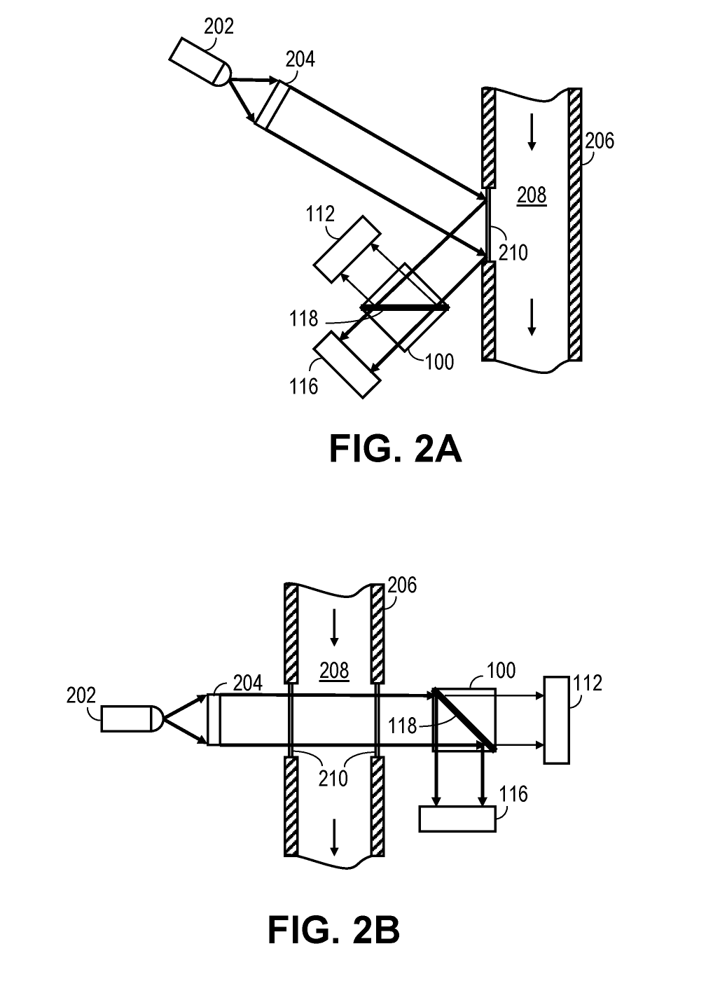

FIGS. 2A and 2B show various example configurations of optical computer 100 and its ICE suitable for identifying a material of interest within a flowing fluid (e.g., hydrocarbons provided by an oil and gas production well). In FIG. 2A, a light source 202 provides a beam of light that is focused by lens 204 on sample window 210. Sample window 210 allows the light to be reflected off of a fluid 208 flowing within pipe 206 and towards optical computer 100 and ICE 118a. The light directed towards the optical computer will have a spectrum reflecting the component materials within fluid 208. ICE 118a of FIG. 2A is configured to reflect the spectrum of interest towards detector 112 while allowing the remaining wavelengths of light to pass through it towards detector 116.

In the example of FIG. 2B, the light beam provided by light source 202 is focused by lens 204 so as to pass through two sample windows 210, as well as fluid 208 within pipe 206, and on towards optical computer 100 and ICE 118b. ICE 118b, unlike ICE 118a, is configured to allow the spectrum of interest to pass through the ICE towards detector 112, while reflecting the remaining wavelengths of light towards detector 116. In the examples of both FIGS. 2A and 2B, detector 112 outputs a signal indicative of the presence and concentration of the material of interest which the ICEs are designed to identify.

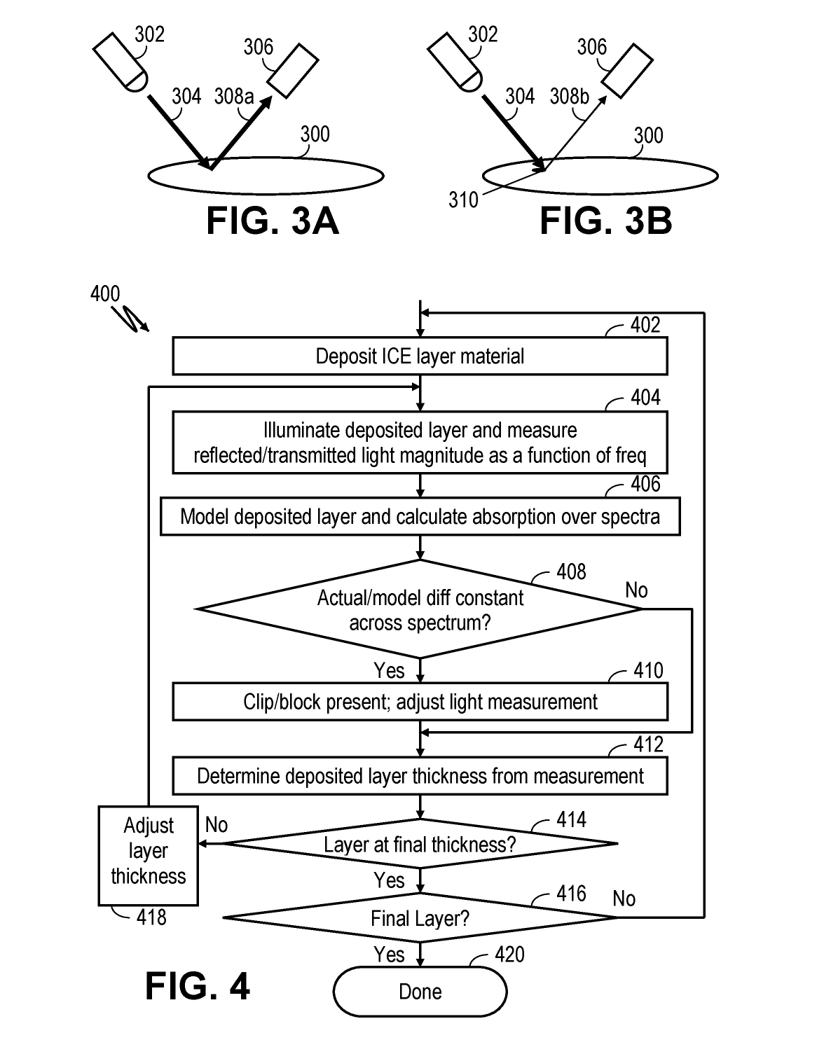

Because the thickness and composition of the ICE layers are factors that determine the specific spectral attributes that will be detected by the ICE, the fabrication of ICE layers must be closely monitored. As previously noted, a measurement light beam can be projected onto an ICE at various stages of production and the reflected light used to determine the thickness of a deposited layer. FIG. 3A shows an illustrative example of the layer of an ICE 300 being measured in this manner. A light source 302 projects a focused incident measurement light beam 304 onto the surface of ICE 300 after a layer has initially been deposited. Reflected light beam 308a is detected and measured by detector 306, and a signal produced by the detector is sampled and processed (e.g., by a digital computer) to determine the thickness of the layer that corresponds to the intensity and spectral characteristics of the reflected light beam 308a.

However, if a contaminant or other foreign material partially or completely blocks the optical path of the light beams, the light detected and measured by detector 306 will not accurately reflect the thickness of the deposited layer. This situation is illustrated in FIG. 3B, where an obstruction 310 partially blocks incident measurement light beam 304, causing reflected light beam 308b to be of a lower intensity than would be produced by the deposited layer, given its actual thickness. As a result, the deposition of the layer will be stopped too soon, resulting in a layer that is too thin and thus a defective ICE, or the layer may be identified as too thick and the ICE discarded as defective, even though it may not be.

The above-described ICE defect scenarios may be addressed by modeling the measurement light beam reflected off of the ICE layer and comparing the model results with the measured results of the light used to determine the thickness of the ICE layer. Such a model simulates the geometric model of the light path, as well as the characteristics of the ICE layers and substrate, for a spectral window corresponding to that of the sampled light. A discrepancy present between the measured spectra and the modeled spectra is indicative of an optical path obstruction. One approach to accounting for this discrepancy is by incorporating a virtual neutral density (VND) layer within the modeling of the measurement light beam reflection. The VND layer accounts for the amount of light that is blocked or clipped. In at least some illustrative embodiments, the optical density or absorption α_{VND} of this VND layer is computed using the formula,

$${∝}_{VND} ( λ ) = - ln \vert Δ I ( λ ) \vert = - ln \vert \frac{{I}_{a} ( λ ) - {I}_{m} ( λ )}{{I}_{0} ( λ )} \vert , \qquad ( 1 )$$

wherein ΔI(λ) represents the difference or discrepancy between the actual reflected or transmitted spectra intensity Iₐ(λ) and the modeled reflected or transmitted spectra intensity Iₘ(λ), normalized to the incident spectra intensity I₀(λ).

In at least some instances, where the thickness of the obstruction exceeds the light penetration depth and the light is completely blocked, the VND optical density value α_{VND} is spectrally independent, i.e., it is not a function of wavelength. This reflects the fact that the blocking/clipping represented by the equation is homogeneous across the spectra of the sampled light. This is in contrast to the various materials used to form the ICE layers, which have absorption properties that change across the spectral window of the sampled light. In other instances, where the obstruction allows light of at least some wavelengths to pass through but blocks and/or reflects other wavelengths, the optical density value α_{VND} is spectrally independent for one or more wavelength ranges, but not over the entire spectral window.

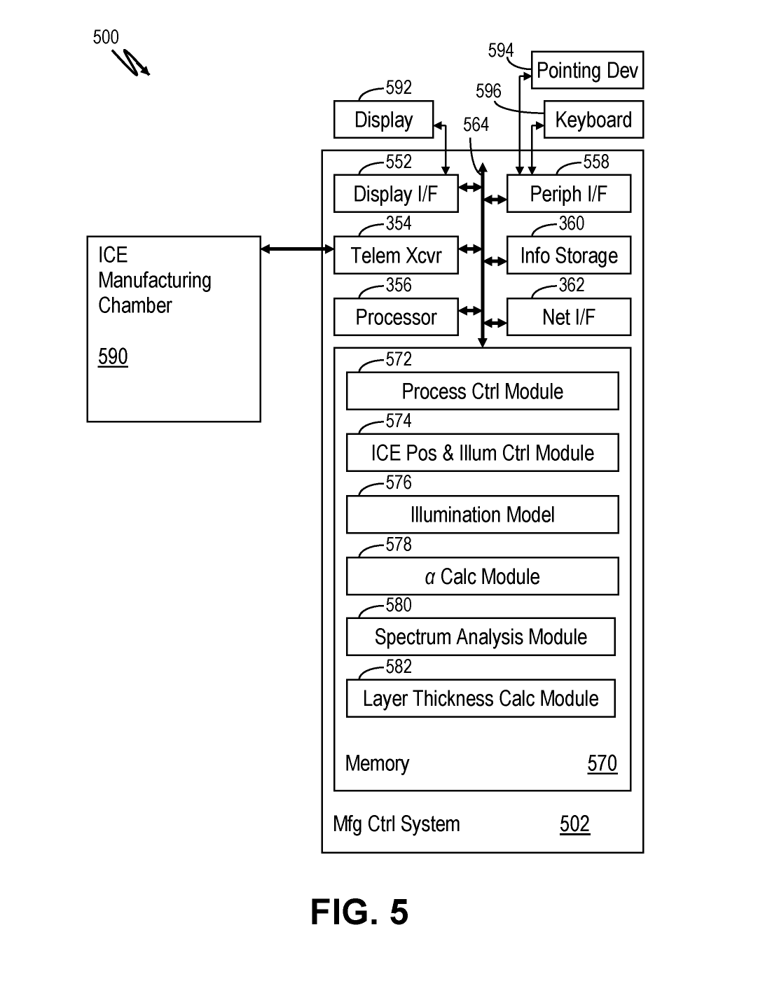

By using equation (1) to quantify and assess discrepancies between measured and modeled measurement light beam values, it is possible to identify and correct for optical path obstructions and ensure that the ICE layers are manufactured to the correct thickness. FIG. 4 shows a flow diagram for an illustrative ICE manufacturing method 400 that incorporates this approach, and FIG. 5 shows an illustrative ICE manufacturing system 500 suitable for implementing method 400. ICE manufacturing system 500 includes a manufacturing control system 502 suitable for monitoring and controlling the manufacturing of an ICE within ICE manufacturing chamber 590. Data is presented to a user via display 592, and the user may further interact with the system via keyboard 596 and pointing device 594 (e.g., a mouse) to control the manufacturing process. If desired, manufacturing control system 502 can be programmed to send such commands automatically in response to automated processing measurements, thus partially or fully automating the ICE manufacturing process.

Located within manufacturing control system 502 is a display interface 552, a telemetry transceiver 554, a processor 556, a peripheral interface 558, an information storage device 560, a network interface 562 and a memory 570. Bus 564 couples each of these elements to each other and transports their communications. Telemetry transceiver 354 enables the manufacturing control system 502 to communicate with the ICE manufacturing chamber 590, and network interface 362 enables communications with other systems (e.g., a central data processing facility via the Internet). In accordance with user input received via peripheral interface 558 and program instructions from memory 570 and/or information storage device 560, processor 556 processes telemetry information received via telemetry transceiver 554 to monitor the ICE manufacturing process and issue appropriate control signals. Storage device 560 may be implemented using any number of known non-transitory information storage media, including but not limited to magnetic disks, solid-state storage devices and optical storage disks.

Various software modules are shown loaded into memory 570 of FIG. 5, where they are each accessed by processor 556 for execution. These modules include: process control module 572, which monitors and controls the actual processing steps performed within ICE manufacturing chamber 590 to produce an ICE; ICE positioning and illumination control module 574, which positions the ICE being manufactured into the proper positions for manufacturing and performing layer measurements, as well as controlling the illumination and measurement of the ICE layers; illumination model 576, which models the light and layers as previously described; α calculation module 578, which performs the optical density calculation of equation (1); spectrum analysis module 580, which analyzes the sampled and modeled light, identifies any discrepancies between the measured and modeled results, and corrects the sampled light measurements if necessary; and layer thickness calculation module 582, which determines the thickness of a deposited layer from the sampled/corrected measurement light.

Referring now to both FIGS. 4 and 5, manufacturing of an ICE begins by depositing an initial ICE layer on a substrate, or continues by depositing an ICE layer onto an existing completed ICE layer (block 402; process control module 572). The ICE is then rotated into a predetermined position so as to allow a measurement light beam to be focused and projected onto the newly deposited layer (block 404; ICE position and illumination control module 574). The measurement light beam is projected at an angle that causes the beam to be reflected off of the ICE and back towards a detector, where the light is sampled, processed and measured (block 404; spectrum analysis module 580). The measurement light beam passing through the newly deposited layers is also modeled based on the expected thickness and known optical properties of the material used to form the layer to produce a modeled expected response of the measurement light (block 406; illumination model 376). The above-described absorption (i.e., optical density value) is calculated (block 408; α calculation module 578) to quantify any difference between the actual measurement light beam magnitude and the modeled measurement light beam magnitude across one or more wavelength windows of the sampled light. If such a difference exists and exceeds an error acceptance value across the spectral window, e.g., the average value of α_{VND} exceeds 0.01 (block 408; spectrum analysis module 580), blocking/clipping has been detected and the actual light measurement is adjusted based upon the calculated optical density value (block 410; spectrum analysis module 580).

Once the actual light measurement has been adjusted (if necessary), the actual light measurement (raw or adjusted) is used to calculate the thickness of the deposited layer (block 412; layer thickness calculation module 582). If the layer is not at the desired thickness (block 414; layer thickness calculation module 582), the thickness is adjusted (block 418; process control module 572), for example by adding more material to the deposited layer if it is too thin. After the adjustment is performed, blocks 404-414 and 418 are repeated as needed until the layer is within a tolerance range of the target thickness (e.g., ±0.1% of target thickness). Once the target layer thickness is achieved (block 414; layer thickness calculation module 582), the entire method is repeated for subsequent layers until the last layer is completed (block 416; process control module 572), ending the method (block 420).

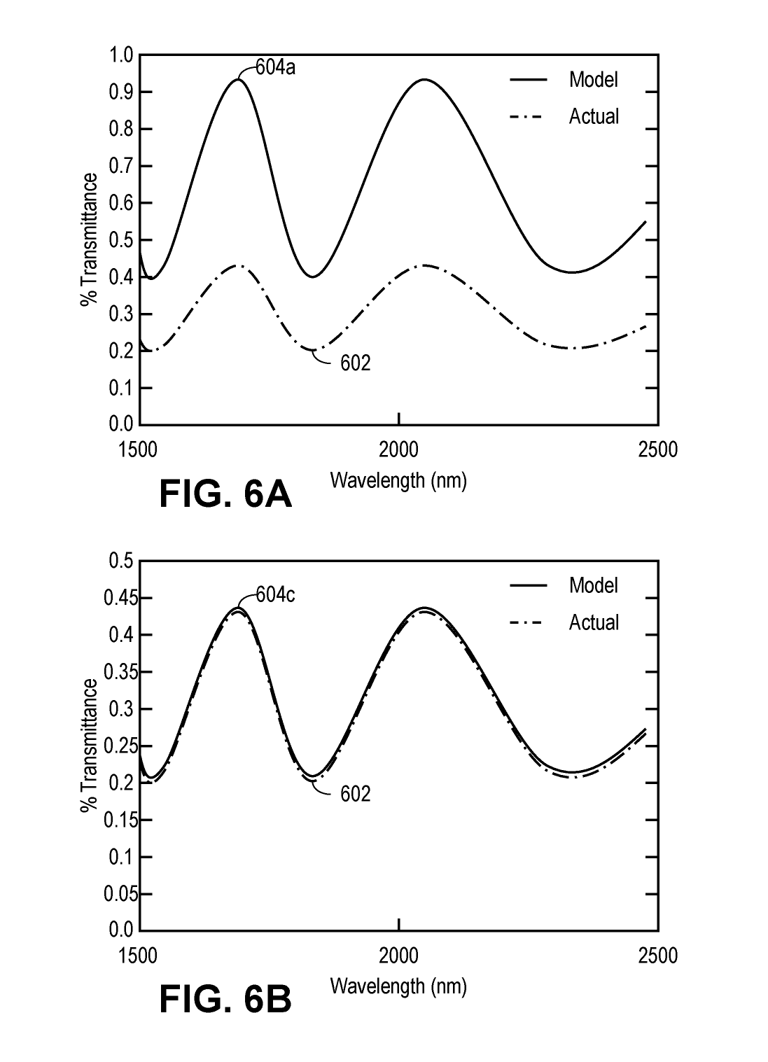

The results of the above described method is best illustrated by graphing the measured (actual) and modeled transmittances of an ICE layer as a function of wavelength, as shown in the graphs of FIGS. 6A and 6B. In the example shown, the spectral window selected is between 1500 and 2500 nanometers. FIG. 6A shows both the reflected light predicted by the illumination model (the solid line) and the actual measured reflected light. As can be seen, there is a significant discrepancy between the two. This discrepancy can be accounted for by comparing the optical densities computed using equation (1). The computed optical density difference quantifies the discrepancy and provides a basis for adjusting the predicted reflected light, as illustrated in FIG. 6B.

Numerous other modifications, equivalents, and alternatives, will become apparent to those skilled in the art once the above disclosure is fully appreciated. For example, although the examples presented describe correcting for the effects of an obstructed measurement light beam, errors/offsets induced in the measurement light beam intensity may be due to other cause, such as a misalignment of the ICE when rotated into position for the measurement operation. The described methods and system may be used to correct for these and other errors/offsets. Further, the corrections applied by the disclosed methods and systems are not limited to thickness measurements, and may also be applied to the determination of optical constants of the measured layer. Additionally, although the described measurement beam configuration reflects the light beam off of the ICE, other embodiments of the disclosed systems and methods may use measurement light beams that instead project the beam through the ICE. It is intended that the following claims be interpreted to embrace all such modifications, equivalents, and alternatives where applicable.

1. A method for correcting a layer thickness of an optical computing element during manufacturing, the method comprising:
depositing a layer of an optical computing element on a substrate or on a previously deposited layer;
illuminating the deposited layer, sampling reflected or transmitted light produced by said illuminating, and measuring an actual magnitude of the sampled light as a function of wavelength;
modeling the sampled light to produce a predicted magnitude of the sampled light;
determining a discrepancy between the actual magnitude and the predicted magnitude, and adjusting the actual magnitude based on said discrepancy;
calculating the thickness of the deposited layer based upon the adjusted actual magnitude of the sampled light; and
adjusting a thickness of the deposited layer if the calculated thickness is not within a tolerance range of a target thickness.

2. An optical computing element manufactured by a method comprising:
depositing a layer of an optical computing element on a substrate or on a previously deposited layer;
illuminating the deposited layer, sampling reflected or transmitted light produced by said illuminating, and measuring an actual magnitude of the sampled light as a function of wavelength;
modeling the sampled light to produce a predicted magnitude of the sampled light;
determining a discrepancy between the actual magnitude and the predicted magnitude, and adjusting the actual magnitude based on said discrepancy;
calculating the thickness of the deposited layer based upon the adjusted actual magnitude of the sampled light; and
adjusting a thickness of the deposited layer if the calculated thickness is not within a tolerance range of a target thickness.

3. An optical computing element manufacturing system, comprising:
a manufacturing chamber;
a light source that illuminates an optical computing element being produced within the manufacturing chamber;
a detector that measures light from the light source reflected off of, or transmitted through, the optical computing element as layers are deposited onto the optical computing element;
a processor coupled to the light source and the detector; and
a memory coupled to the processor and comprising optical computing element manufacturing monitoring and control software;
wherein the software causes the processor to:
initiate the deposition of an optical computing layer on a substrate or on a previously deposited layer;
turn on the light source to illuminate the deposited layer and cause the detector to sample reflected or transmitted light produced by said illuminating and measure an actual magnitude of the sampled light as a function of wavelength;
model the sampled light to produce a predicted magnitude of the sampled light;
determine a discrepancy between the actual magnitude and the predicted magnitude, and adjust the actual magnitude based on said discrepancy;
calculate the thickness of the deposited layer based upon the adjusted actual magnitude of the sampled light; and
initiate an adjustment of a thickness of the deposited layer if the calculated thickness is not within a tolerance range of a target thickness.

4. A non-transitory information storage medium comprising optical computing element manufacturing monitoring and control software that comprises:
a process control module that initiates the deposition of an optical computing layer on a substrate or on a previously deposited layer;
an optical computing element position and illumination control module that turns on a light source to illuminate the deposited layer, and further causes the detector to sample reflected or transmitted light produced by said illuminating and measure an actual magnitude of the sampled light as a function of wavelength;
an illumination model that models the sampled light to produce a predicted magnitude of the sampled light;
a spectrum analysis module that determines a discrepancy between the actual magnitude and the predicted magnitude, and further adjusts the actual magnitude based on said discrepancy; and
a layer thickness calculation module that calculates the thickness of the deposited layer based upon the adjusted actual magnitude of the sampled light;
wherein the process control module further initiates an adjustment of a thickness of the deposited layer if the calculated thickness is not within a tolerance range of a target thickness.

5. The method, system, or medium as provided in claim 1, wherein the presence of a discrepancy is indicative of an obstruction at least partially blocking an optical path between a light source providing the illuminating of the deposited layer and a detector performing the measuring of the sampled light.

6. The method, system, or medium as provided in claim 5, wherein the discrepancy is determined by calculating a difference between an actual reflected or transmitted spectra intensity and a modeled reflected or transmitted spectra intensity, normalized to an incident spectra intensity.

7. The method, system, or medium as provided in claim 6, wherein the discrepancy corresponds to an average optical density value that varies as a function of wavelength by more than an acceptance error value within one or more wavelength ranges.

8. The method, system, or medium as provided in claim 7, wherein the discrepancy is spectrally independent.

9. The method, system, or medium as provided in claim 7, wherein the acceptance error corresponds to an optical density value difference of 0.01.

10. The method, system, or medium as provided in claim 1, wherein the actual magnitude and predicted magnitude are each expressed as fractional transmittance or fractional reflectance values of a real or modeled light source providing the illuminating of the deposited layer.

11. The method, system, or medium as provided in claim 1, wherein the tolerance range is ±0.1% of target thickness.
